(19) United States
(12) Patent Application Publication
(10) Pub. No.: US 2025/0135942 A1
(43) Pub. Date: May 1, 2025

(54) VEHICLE SYSTEMS AND METHODS FOR MANAGING TRANSIENT LOAD FLUCTUATIONS

(71) Applicant: GM GLOBAL TECHNOLOGY OPERATIONS LLC, Detroit, MI (US)

(72) Inventor: William R. Cawthorne, Milford, MI (US)

(73) Assignee: GM GLOBAL TECHNOLOGY OPERATIONS LLC, Detroit, MI (US)

(21) Appl. No.: 18/494,742

(22) Filed: Oct. 25, 2023

(51) Int. Cl. B60L 58/12; B60L 58/20

(52) U.S. Cl. CPC B60L 58/12; B60L 58/20; B60L 2240/549

(57) ABSTRACT

Vehicle systems and methods are provided for controlling converters of a rechargeable energy storage system (RESS). An exemplary method involves identifying an active subset of converters to supply an expected current consumption for one or more electrical loads supplied by the RESS, configuring droop control settings of active converters based at least in part on the expected current consumption, and configuring reserve converters with respective droop control settings different from the respective droop control settings of the active converters. The droop control settings are configured to achieve a desired distribution of the expected current consumption across the active converters and activate the reserve converters to supply supplemental current in response to transient fluctuations where current demand exceeds the expected current consumption.

### INTRODUCTION

The technical field generally relates to vehicle systems and more particularly relates to methods and systems for managing transient fluctuations or variations by the electrical load(s) being powered by a distributed converter system.

Many modern vehicles incorporate rechargeable energy storage systems (“RESS”), such as vehicle batteries, that operate high voltage systems (such a vehicle motor) as well as low voltage systems (such as a vehicle radio, seat warmer, or the like), and typically employ various power converters to supply electrical power from the RESS at different voltage levels. For example, a power inverter or other direct current (DC) to alternating current (AC) converter may be utilized to provide AC electrical power to an electric traction motor at a higher voltage level supported by the RESS, while one or more DC-to-DC converters may be utilized to provide DC electrical power from the RESS to other electrical loads associated with the vehicle at lower voltage levels. Accordingly, it is desirable to provide improved methods and systems for operating power converters to achieve improved efficiency, balancing and/or longevity for the various components of the power converters and/or the RESS. Other desirable features and characteristics of the present disclosure will become apparent from the subsequent detailed description and the appended claims, taken in conjunction with the accompanying drawings and the foregoing technical field and background.

### SUMMARY

Apparatus for a vehicle and related methods and vehicle systems including a rechargeable energy storage system (RESS) are provided. In an exemplary implementation, a method for controlling a plurality of converters that are coupled to a plurality of cells of a RESS and that are configured to supply current to one or more electrical loads involves determining, by a control module coupled to the plurality of converters, an expected current consumption for the one or more electrical loads based at least in part on measurement data obtained via one or more sensors, identifying, by the control module, an active subset of the plurality of converters to supply the expected current consumption based at least in part on the expected current consumption, resulting in a reserve subset of the plurality of converters, wherein the active subset and the reserve subset are mutually exclusive, configuring, by the control module, respective droop control settings of respective active converters of the active subset based at least in part on the expected current consumption, and configuring, by the control module, respective reserve converters of the reserve subset with respective droop control settings different from the respective droop control settings of the respective active converters of the active subset based at least in part on the respective droop control settings of the respective active converters of the active subset.

In one or more implementations, configuring the respective reserve converters of the reserve subset involves configuring the respective reserve converters of the reserve subset for a droop control voltage setpoint that is less than a targeted voltage for the expected current consumption. In one implementation, configuring the respective droop control settings of the respective active converters of the active subset involves configuring the respective active converters of the active subset with respective droop control voltage setpoints greater than the droop control voltage setpoint of the respective reserve converters of the reserve subset to achieve a desired distribution of the expected current consumption across the respective active converters of the active subset at the targeted voltage. In one implementation, configuring the respective reserve converters of the reserve subset involves configuring the respective reserve converters of the reserve subset for a droop control resistance setting that maintains an output voltage greater than a full load voltage of the respective active converters of the active subset.

In one implementation, the method further involves operating the respective reserve converters of the reserve subset to supply at least a portion of the current to the one or more electrical loads when the current is greater than the expected current consumption. In another implementation, configuring the respective reserve converters of the reserve subset involves configuring the respective reserve converters of the reserve subset for a droop control voltage setpoint that prevents the respective reserve converters of the reserve subset from supplying at least a portion of the current to the one or more electrical loads when the current is less than the expected current consumption. In another implementation, configuring the respective droop control settings of the respective active converters of the active subset based at least in part on the expected current consumption involves determining a desired distribution of the expected current consumption across the respective active converters of the active subset based at least in part on cell data for respective cell groups of the plurality of cells associated with the respective active converters of the active subset and configuring the respective droop control settings of respective active converters of the active subset to achieve the desired distribution of the expected current consumption, wherein the respective droop control settings of at least one of the respective active converters of the active subset is different from the respective droop control settings of another active converter of the active subset. In another implementation, configuring the respective reserve converters of the reserve subset with respective droop control settings different from the respective droop control settings of the respective active converters involves configuring the respective reserve converters of the reserve subset with a droop control resistance setting value that is less than a respective droop control resistance setting value for at least one of the respective active converters of the active subset to disproportionately supply at least a portion of the current to the one or more electrical loads via the respective reserve converters of the reserve subset when the current is greater than the expected current consumption.

In one or more exemplary implementations, an apparatus is provided for a non-transitory computer-readable medium having executable instructions stored or encoded thereon that, when executed by a processor, cause the processor to provide one or more services configurable to determine an expected current consumption for one or more electrical loads coupled to a RESS based at least in part on measurement data obtained via one or more sensors, identify an active subset of a plurality of converters that are coupled to a plurality of cells of the RESS and that are configured to supply the expected current consumption to the one or more electrical loads based at least in part on the expected current consumption, resulting in a reserve subset of the plurality of converters, wherein the active subset and the reserve subset are mutually exclusive, configure respective droop control settings of respective active converters of the active subset based at least in part on the expected current consumption, and configure respective reserve converters of the reserve subset with respective droop control settings different from the respective droop control settings of the respective active converters of the active subset based at least in part on the respective droop control settings of the respective active converters of the active subset.

In one or more implementations, the one or more services are configurable to configure the respective reserve converters of the reserve subset for a droop control voltage setpoint that is less than a targeted voltage for the expected current consumption. In a further implementation, the one or more services are configurable to configure the respective active converters of the active subset with respective droop control voltage setpoints greater than the droop control voltage setpoint of the respective reserve converters of the reserve subset to achieve a desired distribution of the expected current consumption across the respective active converters of the active subset at the targeted voltage.

In another implementation, the respective reserve converters of the reserve subset are activated to supply at least a portion of a current to the one or more electrical loads when the current is greater than the expected current consumption. In another implementation, the one or more services are configurable to configure the respective reserve converters of the reserve subset for a droop control voltage setpoint that prevents the respective reserve converters of the reserve subset from supplying at least a portion of a current to the one or more electrical loads when the current is less than the expected current consumption. In another implementation, the one or more services are configurable to determine a desired distribution of the expected current consumption across the respective active converters of the active subset based at least in part on cell data for respective cell groups of the plurality of cells associated with the respective active converters of the active subset and configure the respective droop control settings of respective active converters of the active subset to achieve the desired distribution of the expected current consumption, wherein the respective droop control settings of at least one of the respective active converters of the active subset is different from the respective droop control settings of another active converter of the active subset. In another implementation, the one or more services are configurable to configure the respective reserve converters of the reserve subset with a droop control resistance setting value that is less than a respective droop control resistance setting value for at least one of the respective active converters of the active subset to disproportionately supply at least a portion of a current to the one or more electrical loads via the respective reserve converters of the reserve subset when the current is greater than the expected current consumption.

An apparatus is also provided for a vehicle that includes a RESS that includes a plurality of cells and a plurality of converters that are coupled thereto and that are configured to supply current, one or more electrical loads to receive the current from the RESS, and a control system. The control system includes one or more sensors configured to obtain cell data as to the plurality of cells, the cell data including a state of charge for each of the plurality of cells, and a processor that is coupled to the one or more sensors and to the plurality of converters to provide one or more services configurable to obtain data indicative of an expected current consumption by the one or more electrical loads, identify an active subset of the plurality of converters based at least in part on the expected current consumption, resulting in a reserve subset of the plurality of converters, wherein the active subset and the reserve subset are mutually exclusive, configure respective droop control settings of respective active converters of the active subset based at least in part on the expected current consumption, and configure respective reserve converters of the reserve subset with respective droop control settings different from the respective droop control settings of the respective active converters of the active subset based at least in part on the respective droop control settings of the respective active converters of the active subset.

In one implementation, the respective droop control voltage setpoints of the respective reserve converters of the reserve subset are less than respective droop control voltage setpoints of the respective active converters of the active subset. In a further implementation, the respective droop control voltage setpoints of the respective active converters of the active subset are configured to achieve a desired distribution of the expected current consumption across the respective active converters of the active subset. In another implementation, the respective droop control voltage setpoints of the respective reserve converters of the reserve subset are configured to cause the respective reserve converters of the reserve subset to supply at least a portion of the current to the one or more electrical loads when the current is greater than the expected current consumption. In another implementation, the one or more services are configurable to determine a desired distribution of the expected current consumption across the respective active converters of the active subset based at least in part on the cell data for respective cell groups of the plurality of cells associated with the respective active converters of the active subset and configure the respective droop control settings of respective active converters of the active subset to achieve the desired distribution of the expected current consumption, wherein the respective droop control settings of at least one of the respective active converters of the active subset is different from the respective droop control settings of another active converter of the active subset.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an RESS and a control system for control thereof, among various other components, in accordance with exemplary implementations;

FIG. 2 is a functional block diagram illustrating an RESS that includes a plurality of cell groups and a plurality of DC-to-DC converters, and that can be implemented for the RESS in the vehicle of FIG. 1, in accordance with exemplary implementations;

FIG. 3 is a block diagram of a control module suitable for use with an RESS such as the RESS of FIG. 1 in accordance with one or more exemplary implementations;

FIG. 4 is a graph depicting different relationships between output voltage and output current for converters of the RESS of FIG. 1 configured with different droop control settings by the one or more services of the control module of FIG. 3 in accordance with one or more exemplary implementations; and

FIG. 5 is a flow diagram illustrating an exemplary converter load management process suitable for implementation by one or more services at a control module associated with an RESS in a vehicle according to one or more implementations described herein.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

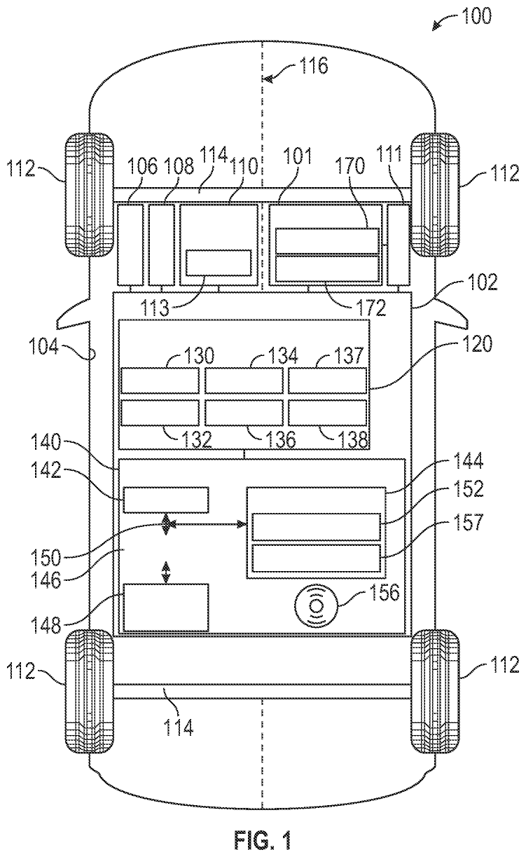

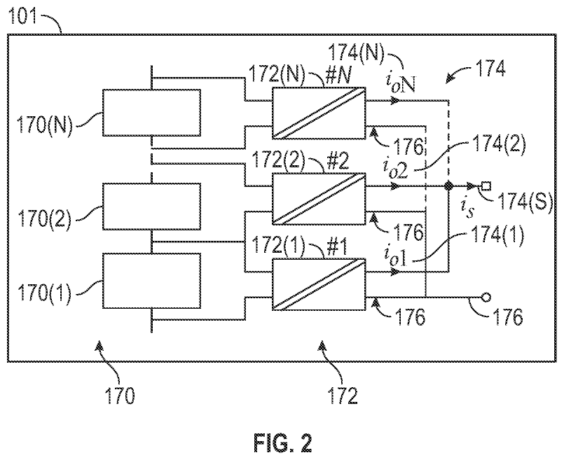

FIG. 1 illustrates a vehicle 100, according to an exemplary implementation. As described in greater detail further below, the vehicle 100 includes, among other components, a rechargeable energy storage system (“RESS”) 101 and a control system 102. In various implementations, the RESS 101 includes a plurality of cell groups 170 and a plurality of direct current to direct current (DC-to-DC) converters 172, for example as depicted in FIG. 2 and described in greater detail further below in connection therewith. Also in various implementations, the control system 102 controls the RESS 101, including via control of operation of the converters 172, to balance the state of charge (SOC) of the cell groups 170 for efficiency and/or to extend longevity of the RESS 101.

As depicted in FIG. 1, the RESS 101 and control system 102 are depicted as part of the vehicle 100 in accordance with exemplary implementations. In various implementations, the vehicle 100 comprises an automobile, such as any one of a number of different types of automobiles, such as, for example, a sedan, a wagon, a truck, sport utility vehicle (SUV), or the like. In certain implementations, the vehicle 100 may also comprise a motorcycle or other vehicle, such as aircraft, spacecraft, watercraft, and so on, and/or one or more other types of mobile platforms (e.g., a robot and/or another mobile platform). In yet other implementations, the RESS 101 and control system 102 may instead be part of and/or coupled to any number of other types of platforms and/or other systems, moving or non-moving, such as a building, infrastructure, and/or other platforms and/or other systems.

In the depicted implementation, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one implementation, the vehicle 100 includes four wheels 112, although this may vary in other implementations (for example for trucks, motorcycles, and certain other vehicles).

A drive system 110 is mounted on the chassis 116, and drives the wheels 112, for example via axles 114. In certain implementations, the drive system 110 comprises a propulsion system having an electric motor 113. In various implementations, the drive system 110, including the motor 113, receives high voltage from the RESS 101.

In various implementations, in addition to providing the high voltage to the motor 113, the RESS 101 also provides low voltage to one or more low voltage systems 111 of the vehicle 100. In various implementations, the low voltage systems 111 may include, by way of example, one or more climate control systems, radio systems, seat warming systems, and so on.

As depicted in FIG. 1, the vehicle also includes a braking system 106 and a steering system 108 in various implementations. In exemplary implementations, the braking system 106 controls braking of the vehicle 100 using braking components that are controlled via inputs provided by a driver (e.g., via a brake pedal) and/or automatically via a control system (such as the control system 102 and/or one or more other control systems). Also in exemplary implementations, the steering system 108 controls steering of the vehicle 100 via steering components that are controlled via inputs provided by a driver (e.g., via a steering wheel), and/or automatically via a control system (such as the control system 102 and/or one or more other control systems).

In the implementation depicted in FIG. 1, the control system 102 is coupled to the RESS 101, receives inputs therefrom, and controls functionality thereof via control of the converters 172. In addition, in certain implementations, the control system 102 is coupled to one or more of the braking system 106, steering system 108, drive system 110, and/or low voltage systems 111, and may also receive inputs from and/or control these additional systems in certain implementations.

Also as depicted in FIG. 1, in various implementations, the control system 102 includes a sensor array 120 and a control module 140 (or controller), as described in greater detail below.

In various implementations, the sensor array 120 includes various sensors that obtain sensor data of the vehicle 100 for use in controlling, among other functionality, the RESS 101, including the converters 172 thereof. In the depicted implementation, the sensor array 120 includes one or more voltage sensors 130, current sensors 132, temperature sensors 134, state of charge sensors 136, brake sensors 137, and steering sensors 138.

In certain implementations, the voltage sensors 130 measure voltage of the RESS 101, including of the various cell groups 170 thereof. Also in certain implementations, the current sensors 132 measure electric current of the RESS 101, including of the cell groups 170 thereof. In various implementations, the temperature sensors 134 measure temperature of the RESS 101, including of the cell groups 170 thereof. Also in various implementations, the state of charge sensors 136 measure state of charge of the RESS 101, including of the cell groups 170 thereof. In addition, various implementations, the brake sensors 137 measure one or more parameters pertaining to the braking system 106 (e.g., braking inputs, braking force, or the like), whereas the steering sensors 138 measure one or more parameters pertaining to the steering system 108 (e.g., steering inputs, steering angle, or the like).

In various implementations, the control module 140 is coupled to the sensor array 120 and receives sensor data therefrom. In various implementations, the control module 140 is further coupled to the RESS 101, including the converters 172 for control thereof. In addition, in certain implementations, the control module 140 may also be coupled to one or more other systems of the vehicle 100, such as the braking system 106, steering system 108, drive system 110, and/or low voltage systems, for example for receiving input thereof and/or for controlling thereof.

In various implementations, the control module 140 controls operation of the converters 172, including with respect to selective charging and discharging of the different cell groups 170 via the converters 172 in order to optimize balance for the cell groups 170 and/or longevity for the converters 172, among other potential functionality for the vehicle 100.

As depicted in FIG. 1, in various implementations, the control module 140 comprises a computer system, and includes a processor 142, a memory 144, an interface 146, a storage device 148, and a computer bus 150.

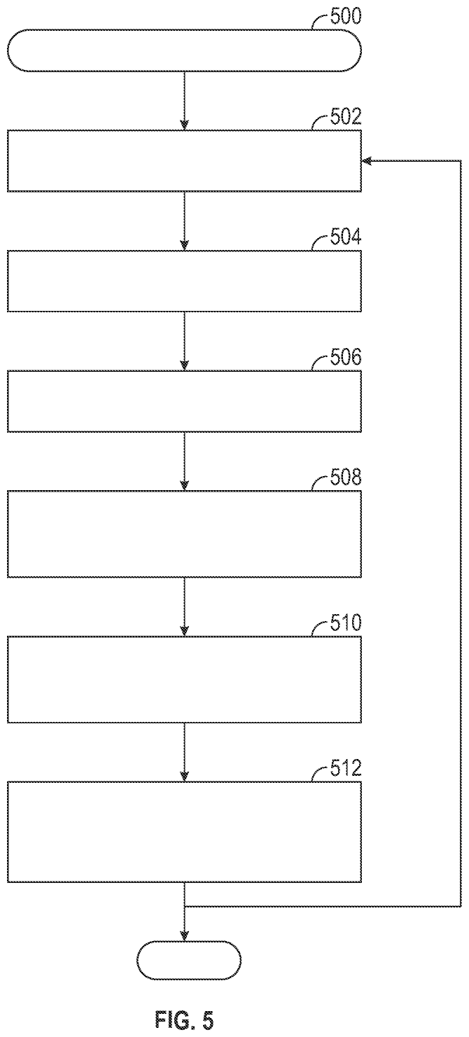

The processor 142 performs the computation and control functions of the control module 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the control module 140 and the computer system of the control module 140, generally in executing the processes described herein, such as the process 500 of FIG. 5 and described further below in connection therewith.

The memory 144 can be any type of suitable memory, including various types of non-transitory computer readable storage medium. In certain examples, the memory 144 is located on and/or co-located on the same computer chip as the processor 142. In the depicted implementation, the memory 144 stores the above-referenced program 152 along with stored values 157 (e.g., look-up tables, thresholds, and/or other values with respect to control of the RESS 101).

The interface 146 allows communication to the computer system of the control module 140, for example from a system driver and/or another computer system, and can be implemented using any suitable method and apparatus. In one implementation, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary implementation, the storage device 148 comprises a program product from which memory 144 can receive a program 152 that executes one or more implementations of one or more processes of the present disclosure, such as the steps of the process 500 of FIG. 5 and described further below in connection therewith. In another exemplary implementation, the program product may be directly stored in and/or otherwise accessed by the memory 144 and/or a disk (e.g., disk 156), such as that referenced below.

The bus 150 serves to transmit programs, data, status and other information or signals between the various components of the computer system of the control module 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a functional diagram of the RESS 101 of FIG. 1, and that includes a plurality of cell groups 170 and DC-to-DC converters 172, in accordance with exemplary implementations.

As depicted in FIG. 2, in various implementations, the RESS 101 includes a number of cell groups 170, such as a first cell group 170(1), a second cell group 170(2), and so on, up to an “nth” cell group 170(N). In practice, each cell group 170 may include one or more battery cells or other energy storage elements that are configured electrically in series and/or parallel to provide a desired DC voltage level and/or DC output current. It will be appreciated that the number and configuration of cell groups 170 may vary in different implementations, and the subject matter described herein is not limited to any particular number, type or configuration of cell groups 170.

Also as depicted in FIG. 2, and also in various implementations, a number of power converters 172 are coupled to the cell groups 170. In the depicted implementation, the converters 172 include a first DC-to-DC converter 172(1), a second DC-to-DC converter 172(2), and so on, up to an “nth” DC-to-DC converter 172(N), where each respective DC-to-DC converter 172 is coupled to a respective subset of one or more of the cell groups 170. It will be appreciated that the number of converters 172 may vary in different implementations, and the subject matter described herein is not limited to any particular number or configuration of DC-to-DC converters 172 and/or cell groups 170.

As depicted in FIG. 2, in various implementations each converter 172 converts a source of direct current (DC) from one or more cell groups 170 from one DC voltage to another DC voltage, which may be different from the cumulative DC voltage of the respective cell group 170 (or subset of cells). In certain implementations, current from one or more cell groups 170 may be selectively utilized for operation of different systems (such as of the vehicle 100 of FIG. 1) in a prioritized order based upon factors such as current states of charge and/or other conditions. In certain implementations, as depicted in FIG. 2, current from various converters 172(1), 172(2), . . . 172(N) (namely, “i₀N”, “iₒ2”, . . . “iₒN”, respectively) may be aggregated as an aggregate current (namely, “iₛ”) for use by the different systems. Also in certain implementations, other electric current 176 may be stored and/or utilized for one or more other purposes, such as for rebalancing of the cell groups 170.

In one or more exemplary implementations, the RESS 101 is configured to function as an auxiliary power module (APM), where the respective cell groups 170 are configured electrically in series to effectively provide a high voltage (HV) battery that supplies electric power in a suitable voltage range (e.g., 350-800 Volts) to primarily provide power to the electric motor 113 of the vehicle propulsion system, while the DC-to-DC converters 172 are utilized to transform electrical energy from the voltage level associated with the respective cell group 170 of the HV battery to a respective voltage level associated with a lower voltage grid of the vehicle electrical system, such as, for example, a 12 Volt grid, a 24 Volt grid, a 48 Volt grid, and/or the like. For example, in one implementation, the HV battery is subdivided into respective cell groups 170 where each cell group 170 is capable of functioning as a respective nominal 12 Volt power supply that can be coupled to the 12 Volt grid via the respective DC-to-DC converter 172 associated with or otherwise allocated to that respective cell group 170. In this regard, multiple instances of cell groups 170 may be selectively configured in parallel to the 12 Volt grid to support the desired amount of DC load current on the grid via the outputs of the respective DC-to-DC converters 172 being configured electrically in parallel. Accordingly, for purposes of explanation, the subject matter may be described herein in the context of the DC-to-DC converters 172 being operated to supply electrical power to a 12 Volt grid of a vehicle electrical system, but one skilled in the art will appreciate the subject matter described herein is not limited to such an implementation.

In exemplary implementations, the DC-to-DC converters 172 are configurable to support or otherwise provide droop control, where the DC voltage that is output by the respective DC-to-DC converter 172 varies depending on the amount of DC current to be supplied to the electrical load(s) via the respective DC-to-DC converter 172. In this regard, as the amount of DC current flow through the respective DC-to-DC converter 172 increases, the output of the respective DC-to-DC converter 172 may linearly decrease in accordance with a droop control setting value. As described in greater detail below, in exemplary implementations described herein, the control module 140 is configurable to dynamically vary the droop control resistance setting value and/or the zero current output voltage setpoint of the respective DC-to-DC converter 172 to achieve the desired distribution of current flow across the different DC-to-DC converters 172 to facilitate balancing the state of charge of the cell groups 170 while maintaining the desired nominal DC voltage of the 12 Volt grid.

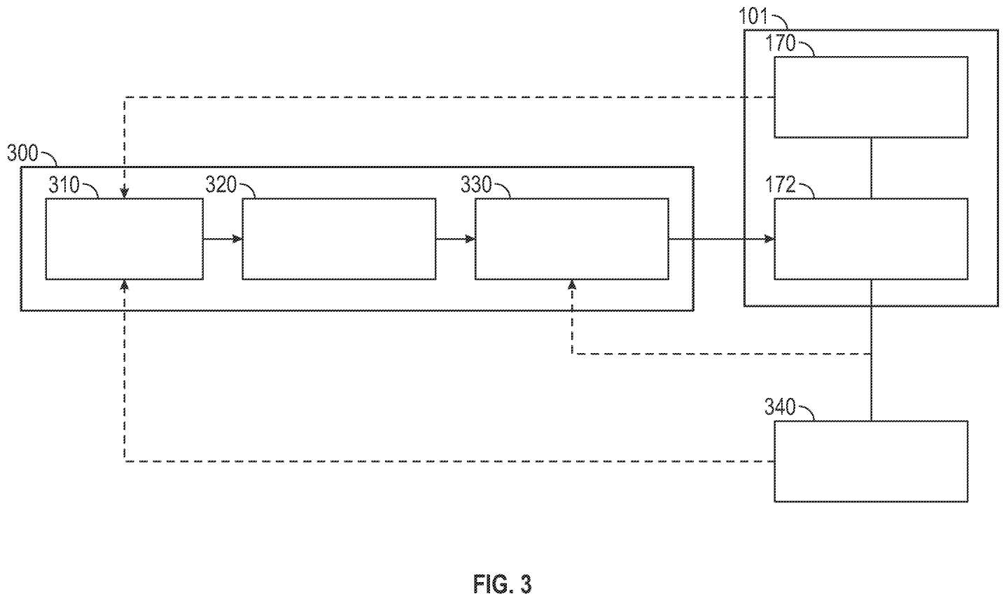

FIG. 3 depicts an exemplary implementation of a control module 300 suitable for use as the control module 140 in the vehicle 100 of FIG. 1. The control module 300 includes a cell balancing service 310 which generally represents the software or other logic implemented at the control module 300 that is configurable to determine which of the DC-to-DC converters 172 should be activated or otherwise enabled to provide current flow from their respective cell groups 170 to satisfy the expected current demand associated with the one or more electrical loads 340 that are coupled to the electrical grid or voltage bus being powered by the DC-to-DC converters 172. The cell balancing service 310 is communicatively coupled to the respective cell groups 170 via the sensor array 120 to receive or otherwise obtain cell data indicative of the respective state of charge (e.g., via state of charge sensors 136) associated with the respective cell groups 170, which, in turn, may be utilized by the cell balancing service 310 to determine which cell groups 170 should be preferentially utilized to supply the expected amount of current that is likely to be needed or demanded by the electrical loads 340. In this regard, the cell balancing service 310 may be communicatively coupled to the electrical loads 340 (e.g., via one or more sensors of the sensor array 120, a communications network and/or the like) to obtain data or information indicative of the current operating state and corresponding current (or power) needs of the respective electrical loads 340. Accordingly, the cell balancing service 310 may determine the number of DC-to-DC converters 172 (or cell groups 170) to be activated in parallel to achieve the expected current demands while maintaining deactivated the DC-to-DC converters 172 associated with the respective cell groups 170 having lower states of charge deactivated to balance the state of charge across the different cell groups 170. For purposes of explanation, the DC-to-DC converters 172 designated for activation to supply power to the electrical loads 340 may be referred to herein as the active converters, while the DC-to-DC converters 172 designated for deactivation to conserve state of charge of their respective cell groups 170 may be referred to herein as the reserve converters.

In one or more exemplary implementations, the cell balancing service 310 determines which of the DC-to-DC converters 172 are to be active (and corresponding cell groups 170 to be depleted to provide power) along with determining a targeted or desired amount of current to be conducted via the respective active converters 172 (or supplied by the respective cell groups 170) in a manner that accounts for the relative states of charge across the cell groups 170 and the efficiency of the respective active converters 172. In this regard, the efficiency of the DC-to-DC converters 172 may vary depending on the relationship between the output voltage and output current, such that the cell balancing service 310 determines a targeted amount of current (or electrical load) for the respective active converters 172 that operates the active converters 172 with a desired efficiency (or within a desired efficiency range) to achieve a desired performance of the active converters 172 while concurrently achieving a desired distribution of current consumption across the respective cell groups 170. For example, in one implementation, a predicted load for the converter set could be determined based on feedback measurements of the present load current, along with additional information about what loads a user may select (e.g., heated seating or the like). An amount of electrical current associated with the anticipated loads to be selected by the user (e.g., the average current, the maximum current, and/or the like) may be added or otherwise combined with the present load current measurement to arrive at the targeted amount of current to be conducted via the respective active converters 172.

The control module 300 includes a converter configuration service 320 which generally represents the software or other logic implemented at the control module 300 that is configurable to receive indicia of the desired active and reserve converters 172 from the converter configuration service 320 and then calculates or otherwise determines the respective droop control settings for the respective converters 172 to achieve the desired operation of the converters 172 and the corresponding power distribution across the active converters 172. In this regard, as described in greater detail below, for the active converters 172, the converter configuration service 320 may calculate or otherwise determine droop control settings including a zero current (or open circuit or no load) droop control output voltage setpoint for the respective active converters 172 along with a corresponding droop resistance that dictates the relationship between the output voltage of the respective active converters 172 and corresponding output current supplied by the respective active converter 172 at the respective output voltage. Accordingly, for the active converters 172, the droop control output voltage setpoint may be set to a DC voltage value that is greater than or equal to the targeted DC voltage or nominal DC voltage for the DC voltage bus coupled between the output of the converters 172 and the electrical loads 340. For example, for a nominal 12 Volt electrical grid, the converter configuration service 320 may determine the droop control output voltage setpoint should be greater than or equal to 12 Volts (e.g., 12.5 Volts). In exemplary implementations, the converter configuration service 320 utilizes the targeted current for the respective active converters 172 provided by the cell balancing service 310 to configure the droop control output voltage setpoint and droop control resistance setting for the respective active converters 172 to achieve the targeted efficiency and current distribution across the active converters 172.

For example, once the baseline droop control settings for the converters 172 are determined, the droop control settings can be adjusted based on the present load characteristics, the desired current for each converter 172 for cell balancing, and the efficiency of the converters 172. For example, for a cell group 170 that is an outlier with relatively higher state of charge, the droop control settings of its associated converter 172 may be configured to draw more current from that cell group 170 by increasing the zero current droop control output voltage setpoint and reducing the droop resistance to raise and flatten the droop voltage curve, such that the converter 172 associated with that cell group 170 supports most of the load before other converters 172 are active. In this regard, the droop control resistance setting may be configured such that the converter 172 associated with the higher SOC cell group 170 operates at or near full current by the point in time at which the output voltage drops below the zero current droop control output voltage setpoint associated with a second set of active converters 172 becomes active to supplement the output current to the load. For example, the zero current droop control output voltage setpoint and the droop control resistance setting values for the second set of active converters 172 may be configured to operate at around 20% of their respective output current capacity in concert with the higher SOC active converter 172 operating closer to 100% when providing the targeted amount of current for the anticipated amount of load, to facilitate rebalancing SOC across the cell groups 170 associated with those active converters 172 (e.g., by bringing the SOC of the higher SOC cell group 170 down to a SOC closer to other ones of the cell groups 170).

For the reserve converters 172, the converter configuration service 320 sets the droop control output voltage setpoint to a DC voltage value that is less than the droop control output voltage setpoint of the active converters 172 such that the reserve converters 172 are deactivated or otherwise maintained in the zero output current state until the present voltage of the DC voltage bus coupled to the output of the respective reserve converters 172 falls below that droop control output voltage setpoint. In this regard, the converter configuration service 320 may be configured to calculate or otherwise determine the respective droop control output voltage setpoint values to provide a desired degree of separation between the active and reserve converters 172 to account for variations across the converters 172 in a manner that is likely to maintain the reserve converters 172 deactivated. Additionally, based on the number of converters 172 designated as active and the expected current demands, the converter configuration service 320 may be configured to calculate or otherwise determine the respective droop control resistance setting values for the active converters 172 to provide the desired slope or relationship between the output current and the output voltage of the active converters 172 to operate at a desired efficiency when providing the expected amount of current to the electrical loads 340. At the same time, the converter configuration service 320 calculates or otherwise determines the respective droop control resistance setting values for the active and reserve converters 172 to provide the desired slope or relationship between the output current and the output voltage of the reserve converters 172 to enable the reserve converters 172 to be automatically activated in response to a transient increase in current demand from the electrical loads 340 to supplement the output current provided by the active converters 172 and maintain the voltage of the DC voltage bus at or above the targeted nominal bus (or grid) voltage. For example, for a 12 Volt bus, the converter configuration service 320 may configure the reserve converters 172 for droop control output voltage setpoint values slightly greater than the targeted or nominal 12 Volt DC bus voltage (e.g., 12.1 Volts) but with respective droop control resistance setting values that ensure the reserve converters 172 begin operating to supply current to the electrical loads 340 prior to the output voltage across the active converters 172 falling below 12 Volts to support or otherwise maintain the 12 Volt DC bus voltage independent of current fluctuations at the electrical loads 340. In exemplary implementations, the droop control output voltage setpoint values for the reserve converters 172 is also greater than the full load voltage (e.g., at the maximum output current capability) of the active converters 172, with the droop control resistance setting values being configured to preferentially supply transient load current from the reserve converters 172 to maintain the active converters 172 at or below the full load voltage.

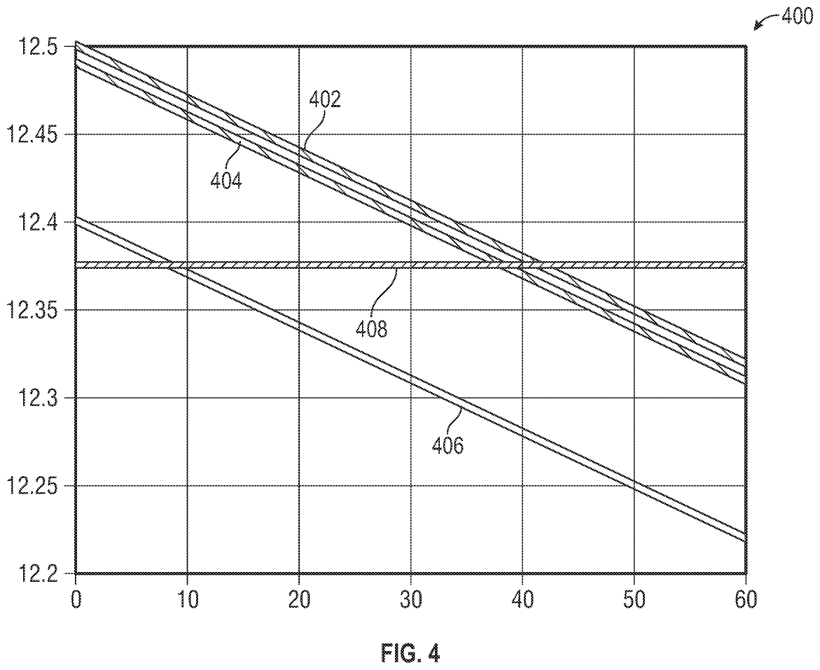

FIG. 4 depicts an exemplary graph 400 depicting the relationship between the output voltage and output current for a pair of active DC-to-DC converters and a reserve DC-to-DC converter in an exemplary implementation. In this regard, FIG. 4 depicts a scenario where a first active DC-to-DC converter is configured for a zero current droop control output voltage setpoint value of 12.5 Volts and a droop control resistance setting value that dictates the slope of a corresponding line 402 depicting the relationship between the output voltage and output current for the respective active DC-to-DC converter. A second active DC-to-DC converter is configured for a zero current droop control output voltage setpoint value of 12.49 Volts and a droop control resistance setting value that dictates the slope of a corresponding line 404 depicting the relationship between the output voltage and output current for the respective active DC-to-DC converter. In this regard, the active DC-to-DC converters may be configured for the same droop control resistance setting value such that the lines 402, 404 depicting the relationship between output voltage and output current are substantially parallel and do not intersect. For example, FIG. 4 may correspond to an implementation configured to provide a targeted amount of 40 Amps of output current at a bus voltage of 12.435 Volts, resulting in the first active DC-to-DC converter supplying 22 Amps of output current and the second active DC-to-DC converter supplying 18 Amps of output current at a bus voltage of 12.435 Volts. In this regard, when the bus voltage at the output of the converters is equal to 12.435 Volts, the reserve DC-to-DC converter having a relationship between the output voltage and output current corresponding to line 406 does not supply output current to the bus.

In the example in FIG. 4, the reserve DC-to-DC converter is configured for a zero current droop control output voltage setpoint value of 12.4 Volts, such that the reserve DC-to-DC converter does not conduct current until the voltage supplied to the electrical loads coupled to the output of the reserve DC-to-DC converter falls below 12.4 Volts. The droop control resistance setting value that dictates the slope of the line 406 depicting the relationship between the output voltage and output current for the respective reserve DC-to-DC converter may be different from the active DC-to-DC converters to enable the reserve DC-to-DC converter to conduct increasing amounts of current to support maintaining a higher DC voltage output across the parallel DC-to-DC converters. In this regard, the line 406 depicting the relationship between output voltage and output current for the reserve DC-to-DC converter may be transverse to or otherwise interest the lines 402, 404 depicting the relationship between output voltage and output current for the active DC-to-DC converters. For example, for the illustrated embodiment, the combination of the zero current droop control output voltage setpoint and droop control resistance setting values for the active DC-to-DC converters may be configured to maintain the voltage of a DC voltage bus coupled to their respective outputs at or above 12.4 Volts until the output current exceeds 63 Amps (e.g., in response to a transient load fluctuation on the bus), as depicted in FIG. 4.

In the illustrated example, FIG. 4 depicts a line 408 corresponding to an operating state of the DC-to-DC converters when the current demand by the electrical load(s) coupled to the DC voltage bus reaches 88 Amps, resulting in the output voltage at the DC-to-DC converters falling to 12.375 Volts, with the first active DC-to-DC converter conducting 42 Amps of current, the second active DC-to-DC converter conducting 38 Amps, and the reserve DC-to-DC converter conducting 8 Amps to help support or otherwise maintain the voltage of the DC voltage bus closer. For example, to ensure the DC bus voltage is maintained at or above 12 Volts, the reserve DC-to-DC converters may be configured for a zero current droop control output voltage setpoint value closer to 12 Volts but with a relative flatter slope to increasingly conduct current as the voltage of the bus approaches 12 Volts to maintain the voltage of the 12 Volt bus above 12 Volts, while the zero current droop control output voltage setpoint and resistance values for the active DC-to-DC converters is tailored to achieve a desired current distribution across their respective cell groups 170 while operating the active DC-to-DC converters with the desired efficiency or performance. In this manner, the active DC-to-DC converters may be tuned or otherwise configured to support the expected electrical loads on the DC voltage bus while achieving the desired state of charge or load balancing of the cell groups 170, while the reserve DC-to-DC converters are tuned or otherwise configured to absorb transient load fluctuations and undergird the bus voltage.

Referring again to FIG. 3, in exemplary implementations, the control module 300 includes a setpoint control service 330 which generally represents the software or other logic implemented at the control module 300 that is configurable to program, instruct, configure or otherwise operate the DC-to-DC converters 172 in accordance with the respective droop control settings and provide closed-loop control to dynamically adjust one or more of the respective droop control settings for one or more of the active DC-to-DC converters 172 based on deviations between the observed operation of the respective active DC-to-DC converters 172 in relation to the droop control settings provided by the converter configuration service 320. For example, due to component variations, manufacturing tolerances and/or other variables, the performance of the respective active DC-to-DC converters 172 may deviate from the expected performance given a particular set of input droop control setting values. For example, with reference to FIG. 4, in one scenario, the second active DC-to-DC converter may be commanded, instructed or otherwise configured for a zero current zero current droop control output voltage setpoint value of 12.5 Volts, but in response to the 12.5 Volt droop control output voltage setpoint command, the second active DC-to-DC converter may instead achieve a relationship between output voltage and output current corresponding to line 404 rather than line 402. In this regard, the setpoint control service 330 may be communicatively coupled to the output of the DC-to-DC converters 172 via the sensor array 120 to receive or otherwise obtain cell data indicative of the output voltage and/or the output current of the respective DC-to-DC converters 172, which, in turn, may be utilized by the setpoint control service 330 to provide closed-loop control of the droop control settings input to the DC-to-DC converters 172 to achieve the desired relationship between the output voltage and output current for the respective active DC-to-DC converters 172.

For example, when a 12.5 Volt droop control output voltage setpoint command results in an active DC-to-DC converter 172 providing an output current at a particular output voltage that indicates a zero current output voltage below 12.5 Volts (e.g., line 404), the setpoint control service 330 may dynamically increase the commanded droop control output voltage setpoint value provided to that active DC-to-DC converter 172 until achieving the desired combination of output voltage and output current. In a similar manner, the setpoint control service 330 may dynamically adjust the droop control resistance setting values for one or more of the active DC-to-DC converter 172 when component variations, manufacturing tolerances and/or other variables cause the active DC-to-DC converter 172 to supply more or less output current than desired for a particular output voltage. In this regard, the setpoint control service 330 may be configurable to provide closed-loop control of the droop control output voltage setpoints and droop control resistance setpoints for the active DC-to-DC converters 172 to achieve the desired distribution of output load current across the respective cell groups 170 associated with the active DC-to-DC converters 172.

In exemplary implementations, each of the services 310, 320, 330 depicted in FIG. 3 are encoded or otherwise stored on a non-transitory computer-readable medium as executable programming instructions for execution by the control module 300 to generate or otherwise facilitate the respective services 310, 320, 330. In this regard, depending on the implementation, the control module 300 can include or be realized as any custom made or commercially available processor, a central processing unit (CPU), a graphics processing unit (GPU), an auxiliary processor among several processors associated with the control module 300, a semiconductor-based microprocessor (in the form of a microchip or chip set), a macroprocessor, any combination thereof, or generally any device for executing instructions to provide the services 310, 320, 330. Moreover, although FIG. 3 depicts the services 310, 320, 330 as separate and distinct, in practice, one or more of the services 310, 320, 330 may be integrated or otherwise combined into a unitary service. In yet other implementations, the services 310, 320, 330 may be implemented in a distributed manner across different instances of control modules, and the subject matter described herein is not intended to be limited to any particular implementation or configuration.

FIG. 5 depicts an exemplary converter load management process 500 suitable for implementation by one or more services associated with a control module controlling operation of a set of electrically parallel power converters of a rechargeable energy storage system (RESS) to achieve a targeted performance while absorbing transient load fluctuations. For illustrative purposes, the following description may refer to elements mentioned above in connection with FIGS. 1-4. While portions of the converter load management process 500 may be performed by different elements of a vehicle system, for purposes of explanation, the subject matter may be primarily described herein in the context of converter load management process 500 being primarily performed by one or more services 310, 320, 330 implemented at a control module 140, 300 associated with a set of parallel DC-to-DC converters 172.

The converter load management process 500 begins by identifying or otherwise determining the expected electrical current consumption by electrical loads to be supplied by the RESS at 502. In this regard, a cell balancing service 310 at a control module 140, 300 may be communicatively coupled to one or more electrical loads 340 connected to a DC voltage bus supported by the RESS 101 either directly or indirectly (e.g., via sensor array 120 measuring current consumption by the electrical loads 340) to receive or otherwise obtain data or information indicative of the amount of current that the respective electrical loads 340 are expected to consume or demand over an upcoming period of time (e.g., the duration of the next control cycle prior to the next iteration of the converter load management process 500). The expected current consumption associated with the respective electrical loads 340 may be aggregated or otherwise combined to arrive at a cumulative expected current to be supplied by the RESS 101 over the next control cycle.

The converter load management process 500 continues by identifying or otherwise determining a number of converters associated with the RESS to be active in supplying the expected current consumption based on one or more electrical characteristics associated with the respective battery cell groups of the RESS at 504. In this regard, based on the relative state of charge measurement values, voltage measurement values and/or the like obtained for the respective cell groups 170 of the RESS 101 via the sensor array 120, the cell balancing service 310 may determine a particular number of cell groups 170 to be utilized to supply the expected current consumption and identify which cell groups 170 should be utilized to supply the expected current consumption over the next control cycle. For example, in one implementation, the cell balancing service 310 identifies a subset of cell groups 170 having the highest state of charge as the cell groups 170 to be utilized, and then identifies the respective DC-to-DC converters 172 associated with those cell groups 170 having the highest state of charge as the active DC-to-DC converters 172 for supplying the expected current consumption over the next control cycle. In practice, the number of active DC-to-DC converters 172 (and corresponding cell groups 170) to be included in the subset of active DC-to-DC converters 172 may be determined by dividing the expected load current by the output current of the DC-to-DC converters 172 that optimizes or maximizes the efficiency of the DC-to-DC converters 172. For example, if the expected load current was 150 Amps and the peak efficiency of the DC-to-DC converters 172 is between 15 Amps to 25 Amps, the cell balancing service 310 may determine between 6 and 10 DC-to-DC converters 172 should be active and arrive at a particular number of active converters between 6 and 10 based on the SOC of the cell groups 170 and other factors. For example, the cell balancing service 310 may determine to activate 8 DC-to-DC converters 172 and identify the DC-to-DC converters 172 associated with the 8 cell groups 170 having the highest SOC values as the active set of DC-to-DC converters 172.

After identifying the subset of active converters, the converter load management process 500 continues at 506 by calculating or otherwise determining one or more performance targets for the active converters and then calculating or otherwise determining corresponding droop control settings for the active converters based on the performance targets at 508. In this regard, in exemplary implementations, based at least in part on the expected current consumption, the current state of charges of the active cell groups 170 associated with the active DC-to-DC converters 172, the performance characteristics associated with the DC-to-DC converters 172, and/or potentially other factors, a converter configuration service 320 may determine the desired distribution of current consumption across the respective active DC-to-DC converters 172 and a corresponding output voltage target for the active DC-to-DC converters 172 at that level of current consumption. Based on the targeted current consumption for a particular active DC-to-DC converters 172 at a targeted output voltage, the converter configuration service 320 may calculate or otherwise determine a corresponding combination of zero current droop control output voltage setpoint and droop control resistance values that is expected to achieve that targeted current consumption at the targeted output voltage for that respective active DC-to-DC converter 172. For example, continuing the example where the cell balancing service 310 determines to activate 8 DC-to-DC converters 172 and identify the DC-to-DC converters 172 associated with the 8 cell groups 170 having the highest SOC values, the converter configuration service 320 may configure the droop control settings of the respective DC-to-DC converters 172 of the active set to supply 18.75 Amps each to achieve the total expected output current of 150 Amps while operating the active DC-to-DC converters 172 associated with the highest SOC cell groups 170 within the peak efficiency output current range between 15 Amps and 25 Amps. Referring to FIG. 4, in the illustrated implementation, the converter configuration service 320 may determine droop control settings for the respective active converters corresponding to lines 402, 404 to achieve an expected current consumption of 40 Amps at a targeted output voltage of 12.435 Volts, as described above.

Referring again to FIG. 5, in exemplary implementations, after determining the droop control settings for the active converters, the converter load management process 500 continues at 510 by calculating or otherwise determining droop control settings for enabling the reserve converters to handle transient load fluctuations based on the configuration of the active converters. In this regard, the converter configuration service 320 determines droop control settings for the reserve DC-to-DC converters 172 converters that are configured to cause the reserve DC-to-DC converters 172 to begin conducting or otherwise supplying current to one or more of the electrical load(s) 340 when the current consumption by the electrical load(s) 340 is greater than the expected electrical current consumption determined at 502. For example, the converter configuration service 320 may configure the zero current droop control output voltage setpoint value for the reserve DC-to-DC converters 172 to be less than the targeted output voltage for the active DC-to-DC converters 172 determined based on the expected current consumption, such that the reserve DC-to-DC converters 172 only begin supplying current to the electrical load(s) 340 when the output voltage falls below the targeted output voltage for the active DC-to-DC converters 172. Referring to FIG. 4, the converter configuration service 320 may determine the zero current droop control output voltage setpoint value for the reserve converter corresponding to line 406 to be equal to 12.4 Volts such that the reserve converter only begins supplying current when the current consumption by the electrical loads exceeds 63 Amps and causes the output voltage of the active converters to fall below the targeted output voltage of 12.4 Volts.

In exemplary implementations, the converter load management process 500 also calculates or otherwise determines the droop control resistance values for the reserve DC-to-DC converters 172 to cause the reserve DC-to-DC converters 172 to disproportionately supply more current to the electrical load(s) 340 as the real-time current consumption exceeds the expected current consumption (e.g., from 502) to cause the output voltage across the parallel DC-to-DC converters 172 to fall below the targeted output voltage for the active DC-to-DC converters 172. In this manner, by configuring the reserve DC-to-DC converters 172 for a greater droop control resistance value relative to the droop control resistance value for the active DC-to-DC converters 172 to provide a relatively flatter relationship between the drop in output voltage and the increase in output current, the reserve DC-to-DC converters 172 may preferentially and disproportionately absorb transient fluctuations to the current consumption or demands by the electrical load(s) 340 to undergird, support, or otherwise maintain the DC bus voltage in the presence of load fluctuations while still maintaining operation of the active DC-to-DC converters 172 closer to performance targets to improve efficiency of operation of the active DC-to-DC converters 172.

By configuring the droop control voltage setpoint for the reserve DC-to-DC converters 172 to be at or within a threshold below the targeted full load voltage of the active DC-to-DC converters 172, the reserve DC-to-DC converters 172 will not actively convert or supply load current for most of the load range of the active DC-to-DC converters 172, where the current consumption is at or below the expected load current. However, if a large current demand is applied to DC voltage bus coupled to the output of the parallel DC-to-DC converters 172, the bus voltage will drop to a level that would engage the reserve DC-to-DC converters 172, by virtue of the relatively fast internal control loops associated with the DC-to-DC converters 172 internally regulating their performance in accordance with the input droop control settings provided by the control module 140, 308 without requiring any intervention from the relatively slower supervisory control module 140, 308 to manage the sudden load spike. Rather, the supervisory control module 140, 308 measures the current or electrical load (e.g., via the sensor array 120) and updates the expected electrical load at 502 on the next iteration of the converter load management process 500 and allocates a greater number of DC-to-DC converters 172 to the active subset and/or moves the droop control voltage setpoint of the current active DC-to-DC converters 172 to a higher voltage level to appropriately rebalance the load among the DC-to-DC converters 172 over the next control cycle.

Referring again to FIG. 5, in exemplary implementations, after determining and configuring the active and reserve converters for the desired droop control settings, the converter load management process 500 continues by monitoring the performance of the converters (e.g., the output voltage and current) and dynamically adjusting the droop control settings for one or more of the converters based on a difference between the observed performance of the respective converter(s) and the targeted performance for the respective converter(s) at 512. For example, for an active DC-to-DC converter 172, a setpoint control service 330 may continually monitor (via the sensor array 120) the measured output current associated with the respective active DC-to-DC converter 172 and the measured output voltage (or DC bus voltage) to detect or otherwise identify a difference between a targeted output current for that output voltage corresponding to the droop control settings for that respective active DC-to-DC converter 172. In this regard, when the current consumption by the active DC-to-DC converter 172 is less than expected for the measured output voltage, the setpoint control service 330 may increase the zero current droop control output voltage setpoint value and/or decrease the droop control resistance value to cause the current provided by the respective active DC-to-DC converter 172 to increase for the same output DC bus voltage. On the other hand, when the current consumption by the active DC-to-DC converter 172 is greater than expected for the measured output voltage, the setpoint control service 330 may decrease the zero current droop control output voltage setpoint value and/or increase the droop control resistance value to cause the current provided by the respective active DC-to-DC converter 172 to decrease for the same output DC bus voltage.

In a similar manner, if a reserve DC-to-DC converter 172 is supplying current at a measured output DC bus voltage that is greater than the zero current droop control output voltage setpoint value provided to that reserve DC-to-DC converter 172, the setpoint control service 330 may decrease the commanded zero current droop control output voltage setpoint value provided to that reserve DC-to-DC converter 172 to prevent the reserve DC-to-DC converter 172 from supplying current that was expected or intended to be supplied by the active DC-to-DC converters 172 for cell balancing purposes. In this manner, the setpoint control service 330 helps achieve the desired cell balancing across the cell groups 170 of the RESS 101 by reducing the likelihood of the reserve DC-to-DC converters 172 unintentionally supplying current at the targeted output voltage for the active DC-to-DC converters 172 while maintaining availability of the reserve DC-to-DC converters 172 to quickly respond to transient load fluctuations.

It should be appreciated that the converter load management process 500 may repeat continually throughout operation of the vehicle 100 to achieve the desired cell balancing across cell groups 170 of the RESS 101 to prolong longevity of the RESS 101 while also operating the DC-to-DC converters 172 in a manner that achieves a targeted performance or efficiency, thereby further prolonging the availability of the RESS 101. In this regard, the converter load management process 500 may dynamically vary which cell groups 170 and converters 172 are active during any particular control cycle to achieve the desired balancing of utilization across the cell groups 170, while allowing the temporarily inactive reserve cell groups 170 and converters 172 to dynamically respond to transient load fluctuations to supplement the active cell groups 170 and converters 172 substantially in real-time.

By virtue of the subject matter described herein, the efficiency of a vehicle electrical system with multiple DC-to-DC converters configured electrically in parallel can by increased by using different droop control settings to operate a subset of active DC-to-DC converters with a respective load (e.g., combination of output voltage and current) that is close to (or within a threshold range of) an optimal or peak efficiency point of the respective converters. In this regard, to maximize efficiency of those active converters, another mutually exclusive subset of the DC-to-DC converters may be configured as reserve converters that are not intended to be actively converting given the expected electrical load. That said, the droop control settings of the reserve converters may be configured such that the reserve converters temporarily activate in response to a transient or unexpected increase in the electrical load to support or otherwise maintain the voltage of the DC voltage bus coupled to the outputs of the DC-to-DC converters while maintaining ability to operate the active subset of DC-to-DC converters efficiently if or when the current demand subsides.

As described above, the droop control output voltage setpoint may be configured for the active DC-to-DC converters to achieve the desired load sharing across the active DC-to-DC converters (e.g., to achieve the desired balancing of state of charge across the respective battery cell groups or other energy sources supplying the input power to the active DC-to-DC converters), while the droop control output voltage setpoint may be configured for the reserve DC-to-DC converters to support sudden transient increases in the electrical load that occur before the DC-to-DC converters can be reconfigured and/or reallocated to the active subset. In this manner, the droop control settings can be utilized to regulate the output voltage and handle load fluctuations while also ensuring load sharing and balancing the load on the input side energy sources.

For sake of brevity, conventional techniques related to vehicle electrical systems, RESSs, power converters, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an implementation of the subject matter.

As used herein, the word “exemplary” means “serving as an example, instance, or illustration.” Thus, any implementation described herein as “exemplary” is not necessarily to be construed as preferred or advantageous over other implementations. All of the implementations described herein are exemplary implementations provided to enable persons skilled in the art to make or use the invention and not to limit the scope of the invention which is defined by the claims.

Those of skill in the art will appreciate that the various illustrative logical blocks, modules, circuits, and algorithm steps described in connection with the implementations disclosed herein may be implemented as electronic hardware, computer software, or combinations of both. Some of the implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is logically coherent.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing the exemplary aspect or exemplary aspects. It should be understood that various changes can be made in the function and arrangement of elements without departing from the scope of the disclosure as set forth in the appended claims and the legal equivalents thereof.

What is claimed is:

1. A method for controlling a plurality of converters that are coupled to a plurality of cells of a rechargeable energy storage system (RESS) and that are configured to supply current to one or more electrical loads, the method comprising:
determining, by a control module coupled to the plurality of converters, an expected current consumption for the one or more electrical loads based at least in part on measurement data obtained via one or more sensors;
identifying, by the control module, an active subset of the plurality of converters to supply the expected current consumption based at least in part on the expected current consumption, resulting in a reserve subset of the plurality of converters, wherein the active subset and the reserve subset are mutually exclusive;
configuring, by the control module, respective droop control settings of respective active converters of the active subset based at least in part on the expected current consumption; and
configuring, by the control module, respective reserve converters of the reserve subset with respective droop control settings different from the respective droop control settings of the respective active converters of the active subset based at least in part on the respective droop control settings of the respective active converters of the active subset.

2. The method of claim 1, wherein configuring the respective reserve converters of the reserve subset comprises configuring the respective reserve converters of the reserve subset for a droop control voltage setpoint that is less than a targeted voltage for the expected current consumption.

3. The method of claim 2, wherein configuring the respective droop control settings of the respective active converters of the active subset comprises configuring the respective active converters of the active subset with respective droop control voltage setpoints greater than the droop control voltage setpoint of the respective reserve converters of the reserve subset to achieve a desired distribution of the expected current consumption across the respective active converters of the active subset at the targeted voltage.

4. The method of claim 2, wherein configuring the respective reserve converters of the reserve subset comprises configuring the respective reserve converters of the reserve subset for a droop control resistance setting that maintains an output voltage greater than a full load voltage of the respective active converters of the active subset.

5. The method of claim 1, further comprising operating the respective reserve converters of the reserve subset to supply at least a portion of the current to the one or more electrical loads when the current is greater than the expected current consumption.

6. The method of claim 1, wherein configuring the respective reserve converters of the reserve subset comprises configuring the respective reserve converters of the reserve subset for a droop control voltage setpoint that prevents the respective reserve converters of the reserve subset from supplying at least a portion of the current to the one or more electrical loads when the current is less than the expected current consumption.

7. The method of claim 1, wherein configuring the respective droop control settings of the respective active converters of the active subset based at least in part on the expected current consumption comprises:
determining a desired distribution of the expected current consumption across the respective active converters of the active subset based at least in part on cell data for respective cell groups of the plurality of cells associated with the respective active converters of the active subset; and
configuring the respective droop control settings of respective active converters of the active subset to achieve the desired distribution of the expected current consumption, wherein the respective droop control settings of at least one of the respective active converters of the active subset is different from the respective droop control settings of another active converter of the active subset.

8. The method of claim 1, wherein configuring the respective reserve converters of the reserve subset with respective droop control settings different from the respective droop control settings of the respective active converters comprises configuring the respective reserve converters of the reserve subset with a droop control resistance setting value that is less than a respective droop control resistance setting value for at least one of the respective active converters of the active subset to disproportionately supply at least a portion of the current to the one or more electrical loads via the respective reserve converters of the reserve subset when the current is greater than the expected current consumption.

9. A non-transitory computer-readable medium comprising executable instructions that, when executed by a processor, cause the processor to provide one or more services configurable to:
determine an expected current consumption for one or more electrical loads coupled to a rechargeable energy storage system (RESS) based at least in part on measurement data obtained via one or more sensors;
identify an active subset of a plurality of converters that are coupled to a plurality of cells of the RESS and that are configured to supply the expected current consumption to the one or more electrical loads based at least in part on the expected current consumption, resulting in a reserve subset of the plurality of converters, wherein the active subset and the reserve subset are mutually exclusive;
configure respective droop control settings of respective active converters of the active subset based at least in part on the expected current consumption; and
configure respective reserve converters of the reserve subset with respective droop control settings different from the respective droop control settings of the respective active converters of the active subset based at least in part on the respective droop control settings of the respective active converters of the active subset.

10. The non-transitory computer-readable medium of claim 9, wherein the one or more services are configurable to configure the respective reserve converters of the reserve subset for a droop control voltage setpoint that is less than a targeted voltage for the expected current consumption.

11. The non-transitory computer-readable medium of claim 10, wherein the one or more services are configurable to configure the respective active converters of the active subset with respective droop control voltage setpoints greater than the droop control voltage setpoint of the respective reserve converters of the reserve subset to achieve a desired distribution of the expected current consumption across the respective active converters of the active subset at the targeted voltage.

12. The non-transitory computer-readable medium of claim 9, wherein the respective reserve converters of the reserve subset are activated to supply at least a portion of a current to the one or more electrical loads when the current is greater than the expected current consumption.

13. The non-transitory computer-readable medium of claim 9, wherein the one or more services are configurable to configure the respective reserve converters of the reserve subset for a droop control voltage setpoint that prevents the respective reserve converters of the reserve subset from supplying at least a portion of a current to the one or more electrical loads when the current is less than the expected current consumption.

14. The non-transitory computer-readable medium of claim 9, wherein the one or more services are configurable to:
determine a desired distribution of the expected current consumption across the respective active converters of the active subset based at least in part on cell data for respective cell groups of the plurality of cells associated with the respective active converters of the active subset; and
configure the respective droop control settings of respective active converters of the active subset to achieve the desired distribution of the expected current consumption, wherein the respective droop control settings of at least one of the respective active converters of the active subset is different from the respective droop control settings of another active converter of the active subset.

15. The non-transitory computer-readable medium of claim 9, wherein the one or more services are configurable to configure the respective reserve converters of the reserve subset with a droop control resistance setting value that is less than a respective droop control resistance setting value for at least one of the respective active converters of the active subset to disproportionately supply at least a portion of a current to the one or more electrical loads via the respective reserve converters of the reserve subset when the current is greater than the expected current consumption.

16. A vehicle comprising:
a rechargeable energy (RESS) that includes a plurality of cells and a plurality of converters that are coupled thereto and that are configured to supply current;
one or more electrical loads to receive the current from the RESS; and
a control system comprising:
one or more sensors configured to obtain cell data as to the plurality of cells, the cell data including a state of charge for each of the plurality of cells; and
a processor that is coupled to the one or more sensors and to the plurality of converters to provide one or more services configurable to:
obtain data indicative of an expected current consumption by the one or more electrical loads;
identify an active subset of the plurality of converters based at least in part on the expected current consumption, resulting in a reserve subset of the plurality of converters, wherein the active subset and the reserve subset are mutually exclusive;
configure respective droop control settings of respective active converters of the active subset based at least in part on the expected current consumption; and
configure respective reserve converters of the reserve subset with respective droop control settings different from the respective droop control settings of the respective active converters of the active subset based at least in part on the respective droop control settings of the respective active converters of the active subset.

17. The vehicle of claim 16, wherein respective droop control voltage setpoints of the respective reserve converters of the reserve subset are less than respective droop control voltage setpoints of the respective active converters of the active subset.

18. The vehicle of claim 17, wherein the respective droop control voltage setpoints of the respective active converters of the active subset are configured to achieve a desired distribution of the expected current consumption across the respective active converters of the active subset.

19. The vehicle of claim 16, wherein the respective droop control voltage setpoints of the respective reserve converters of the reserve subset are configured to cause the respective reserve converters of the reserve subset to supply at least a portion of the current to the one or more electrical loads when the current is greater than the expected current consumption.

20. The vehicle of claim 16, wherein the one or more services are configurable to:
determine a desired distribution of the expected current consumption across the respective active converters of the active subset based at least in part on the cell data for respective cell groups of the plurality of cells associated with the respective active converters of the active subset; and
configure the respective droop control settings of respective active converters of the active subset to achieve the desired distribution of the expected current consumption, wherein the respective droop control settings of at least one of the respective active converters of the active subset is different from the respective droop control settings of another active converter of the active subset.
